(19) United States
(12) Patent Application Publication
(10) Pub. No.: US 2026/0154152 A1
(43) Pub. Date: Jun. 4, 2026

(54) METHOD FOR PROCESSING VIDEO EXPORT, ELECTRONIC DEVICE, AND STORAGE MEDIUM

(71) Applicant: Beijing Zitiao Network Technology Co., Ltd., Beijing (CN)

(72) Inventors: Huazhou WEN, Beijing (CN); Kui QIU, Beijing (CN)

(21) Appl. No.: 19/368,917

(22) Filed: Oct. 24, 2025

(30) Foreign Application Priority Data
Nov. 29, 2024 (CN) 202411751333.8

(51) Int. Cl. G06F 11/10; G06F 11/07

(52) U.S. Cl. CPC G06F 11/1012; G06F 11/0727; G06F 11/079

(57) ABSTRACT

The present disclosure provides a method for processing video export, an electronic device, and a storage medium. The method includes: in an exporting process of a video edit draft, in response to a detected export failure event, determining a device operating system of a device running a video editing application and an export error code corresponding to the export failure event; determining an export failure type of the export failure event according to the device operating system and the export error code; and acquiring an export preprocessing strategy corresponding to the export failure type, and displaying a failure prompt page according to the export preprocessing strategy, wherein the failure prompt page includes a prompt operation control which is configured to execute a processing operation corresponding to the export preprocessing strategy.

### CROSS-REFERENCE TO RELATED APPLICATION

This application claims the priority to and benefits of the Chinese Patent Application, No. 202411751333.8, which was filed on Nov. 29, 2024. The aforementioned patent application is hereby incorporated by reference in its entirety.

### TECHNICAL FIELD

Embodiments of the present invention relate to the technical field of video editing, and specifically relates to a method for processing video export, an electronic device and a storage medium.

### BACKGROUND

In video editing scenarios, users usually export videos after editing, and it may fail in the video exporting process. At present, video editing applications only prompt and guide the users to retry when detecting export failures, but many problems that cause export failures cannot be solved by retrying, thus increasing negative feedback for video exporting.

### SUMMARY

Embodiments of the present disclosure provide a method for processing video export, an electronic device and a storage medium, so as to solve the problem that the solutions for the video export failure are single, the stability of the video export function is improved, and the negative feedback of the video export is reduced.

An embodiment of the present disclosure provides a method for processing video export, which comprises:
in an exporting process of a video edit draft, in response to a detected export failure event, determining a device operating system of a device running a video editing application and an export error code corresponding to the export failure event:
determining an export failure type of the export failure event according to the device operating system and the export error code; and
acquiring an export preprocessing strategy corresponding to the export failure type, and displaying a failure prompt page according to the export preprocessing strategy,
wherein the failure prompt page comprises a prompt operation control which is configured to execute a processing operation corresponding to the export preprocessing strategy.

An embodiment of the present disclosure provides an apparatus for processing video export, which comprises:
an export error code determination module, configured to: in an exporting process of a video edit draft, in response to a detected export failure event, determine a device operating system of a device running a video editing application and an export error code corresponding to the export failure event;
an export failure type determination module, configured to determine an export failure type of the export failure event according to the device operating system and the export error code; and
a failure prompt page display module, configured to acquire an export preprocessing strategy corresponding to the export failure type, and displaying a failure prompt page according to the export preprocessing strategy; and
wherein the failure prompt page comprises a prompt operation control which is configured to execute a processing operation corresponding to the export preprocessing strategy.

An embodiment of the present disclosure provides an electronic device, which comprises:
at least one processor; and
a memory communicatively connected with the at least one processor, wherein
the memory stores a computer program executable by the at least one processor, and the computer program, when executed by the at least one processor, causes the at least one processor to perform the method for processing video export according to the above-mentioned embodiments.

An embodiment of the present disclosure provides a computer program product, the computer program comprising a computer program which is executed by a processor to execute the method for processing video export according to the above-mentioned embodiments.

### BRIEF DESCRIPTION OF DRAWINGS

In conjunction with the accompanying drawings and with reference to the following specific embodiments, the above and other features, advantages and aspects of each embodiment of the present invention will become more obvious. Throughout the accompanying drawings, identical or similar marks in the accompanying drawings indicate the same or similar elements. It is to be understood that the accompanying drawings are schematic, and originals and elements will not be necessarily drawn to scale.

FIG. 1 is a flowchart of a method for processing video export provided by an embodiment of the present invention;

FIG. 2 is a schematic diagram of a failure prompt page generated according to an edit page returning strategy provided by an embodiment of the present invention:

FIG. 3 is a schematic diagram of a failure prompt page generated according to an entry page returning strategy provided by an embodiment of the present invention:

FIG. 4 is a schematic diagram of a failure prompt page generated according to a device restarting strategy provided by an embodiment of the present invention:

FIG. 5 is a flowchart of another method for processing video export provided by an embodiment of the present invention:

FIG. 6 is a schematic diagram of a failure prompt page generated according to a cache cleaning strategy provided by an embodiment of the present invention:

FIG. 7 is a schematic diagram of a failure prompt page generated according to a recycle bin cleaning strategy provided by an embodiment of the present invention:

FIG. 8 is a schematic diagram of a failure prompt page generated according to a system space cleaning strategy provided by an embodiment of the present invention:

FIG. 9 is a schematic structural diagram of an apparatus for processing video export provided by an embodiment of the present invention; and

FIG. 10 is a schematic structural diagram of an electronic device provided by an embodiment of the present invention.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may comprise additional steps and/or steps omitted or unshown. The scope of the present disclosure is not limited in this aspect.

The term “comprising” and variations thereof used in this article are open-ended inclusion, namely “comprising but not limited to”. The term “based on” refers to “at least partially based on”. The term “one embodiment” means “at least one embodiment”: the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units. Modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

It may be understood that before using the technical solutions disclosed in the embodiments of the present disclosure, the types, scope of use, and usage scenarios of personal information involved in the present disclosure and the like shall be informed to the user and the user's authorization shall be obtained in an appropriate manner in accordance with relevant laws and regulations.

For example, when receiving an active request from a user, a prompt message is sent to the user to explicitly prompt the user that an operation requested by the user will need to obtain and use the user's personal information. In this way, the user can choose whether to provide personal information to a software or hardware such as an electronic device, an application, a server, or a storage medium that performs the operation of the technical solution of the present disclosure according to the prompt message.

As an optional but non-limiting implementation, in response to receiving an active request from a user, the prompt message may be sent to the user in the form of a pop-up window, and the prompt message may be presented in the pop-up window in the form of text. In addition, the pop-up window may also carry a selection control for the user to select “agree” or “disagree” to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

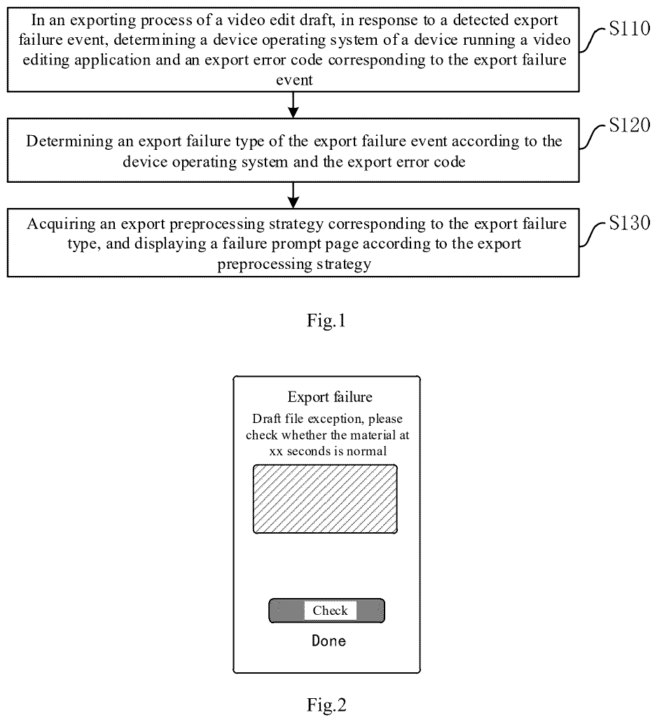

FIG. 1 is a flowchart of a method for processing video export provided by an embodiment of the present invention. This embodiment is suitable for a situation of exporting video edit drafts in a video editing application, especially for a situation that export failure events occur in the exporting process. This method can be performed by a processing apparatus for video export, which can be implemented in a form of hardware and/or software. The processing apparatus for video export can be configured in an electronic device, typically in a mobile terminal or a tablet computer. As shown in FIG. 1. the method comprises:

S110: in an exporting process of a video edit draft, in response to a detected export failure event, determining a device operating system of a device running a video editing application and an export error code corresponding to the export failure event.

Specifically, the video edit draft represents video content edited and created by a user in the video editing application, and the video editing application provides an export function of the video edit draft, which is used for converting the video edit draft into a video file in a specified video format. The export failure event may represent that the exporting process of the video edit draft is interrupted.

In an optional embodiment, the method further comprises: in the exporting process of the video edit draft, monitoring whether a preset export index is abnormal, and if so, interrupting the exporting process of the video edit draft, and generating the export failure event. Exemplarily, monitoring the preset export index comprises but is not limited to monitoring whether the video output format, video resolution, video frame rate and other index parameters are consistent with item settings, monitoring whether a video export path is correct, monitoring whether the file name and extension name of the video file are valid, monitoring whether a disk has enough storage space for storing the video file, whether there is plug-in incompatibility, etc.; and the detection mode for the export failure event is not limited, which can be specifically set in a customized mode according to actual demands.

The device operating system is a program for managing computer hardware and software resources, which runs directly in hardware of a computer, and any other software can only run with the support of the device operating system. The device operating system serves as an interface between the user and the computer, as well as an interface between computer hardware and other software; and the main functions of the system comprise managing hardware, software and data resources of the computer system, controlling program execution, improving a human-computer interface, providing support for other application software, etc., so as to maximize the utilization of all resources in the computer system.

In a specific embodiment, when the device running the video editing application is a computer terminal, the device operating system is a desktop operating system; and when the device running the video editing application is a mobile terminal, the device operating system is a mobile operating system. Exemplarily, the desktop operating system comprises but is not limited to Windows system, mac system, Linux system, Zorin system and the like, while the mobile operating system comprises but is not limited to Android system, IOS system, Harmon system and the like.

Specifically, the export error code represents a code that identifies and records the reasons for export failure events in the device operating system, and exemplarily, the export error code may be acquired from video export logs.

S120: determining an export failure type of the export failure event according to the device operating system and the export error code.

Specifically, the export failure type is used for indicating the reasons for the export failure events, and in different device operating systems, it will set one or more export error codes for the same export failure type. In an optional embodiment, the determining an export failure type of the export failure event according to the device operating system and the export error code comprises: acquiring an export error code list corresponding to the device operating system, in which, the export error code list comprises an error code sequence corresponding to at least one preset failure type, and the error code sequence comprises at least one preset error code; and searching the export failure type of the export failure event from the export error code list according to the export error code.

Specifically, the preset failure type represents the class of the failure reason corresponding to each preset error code in the error code sequence belongs. In an optional embodiment, the export error list comprises at least one preset failure type of disk space warning, draft file exception, decoder exception and encoder exception.

Exemplarily, when the device operating system is the IOS system, the error code sequence corresponding to the disk space warning comprises 3302, 3305, −3000, −113, −241, −1001, −11807, etc.; and when the device operating system is the Android system, the error code sequence corresponding to the disk space warning comprises −113. When the device operating system is the IOS system, the error code sequence corresponding to the draft file exception comprises −142; and when the device operating system is the Android system, the error code sequence corresponding to the draft file exception comprises −142, −328, and −109499529. When the device operating system is the IOS system, the error code sequence corresponding to the decoder exception comprises −13 and −12912; and when the device operating system is the Android system, the error code sequence corresponding to the decoder exception comprises −312, −330), and 4390. When the device operating system is the IOS system, the error code sequence corresponding to the encoder exception comprises −12912, −12907, and −12915.

There is no limitation to the error code sequences corresponding to different device operating systems and different preset failure types, and the error code sequences can be customized according to failure reasons respectively represented by other currently known preset error codes and preset error codes to be developed in the future. Moreover, there is also no limitation to the preset failure types corresponding to different device operating systems, some preset failure types such as the disk space warning, draft file exception, decoder exception and encoder exception are taken for exemplary explanation in this embodiment, and the preset failure types can be customized and classified according to the failure reasons respectively represented by other currently known preset error codes and preset error codes to be developed in the future.

S130: acquiring an export preprocessing strategy corresponding to the export failure type, and displaying a failure prompt page according to the export preprocessing strategy.

In this embodiment, the failure prompt page comprises a prompt operation control which is configured to execute a processing operation corresponding to the export preprocessing strategy. Specifically, the export preprocessing strategy represents solutions set for different export failure types.

In an optional embodiment, the prompt operation control is provided with a control prompt text. Exemplarily, the control prompt text may be a name of the export preprocessing strategy, or customized description related to the export preprocessing strategy.

On the basis of the above embodiment, optionally, the failure prompt page further comprises failure prompt message which comprises the export failure type and/or strategy description content corresponding to the export preprocessing strategy.

The setting of the control prompt text and/or the failure prompt message has the advantages that the user is assisted in knowing the export failure event and the export preprocessing strategy, and a reference is provided for the user to select whether to trigger the prompt operation control.

On the basis of the above embodiment, optionally, the failure prompt page further comprises a status display control which is configured to execute to display a video export page corresponding to the export failure event. In the video export page corresponding to the export failure event, the displayed export progress is greater than or equal to 0% and less than 100%.

Generally, the user triggers the prompt operation control or the status display control in the failure prompt page, and the s status display control represents that the user selects not to execute the processing operation corresponding to the export preprocessing strategy.

The setting of the status display control has the advantages that the diversity of next executable selection operations for the user in the export failure event is enriched, thereby further reducing the negative feedback of video export.

In an optional embodiment, the acquiring an export preprocessing strategy corresponding to the export failure type comprises: when the export failure type is the draft file exception, taking an edit page returning strategy as the export preprocessing strategy, in which, the edit page returning strategy represents displaying the video edit page.

Exemplarily, failures such as absence of audio and video clips represented by corresponding “−142”, absence of picture files represented by corresponding “−328”, and file data exception represented by corresponding “−109499529” in the Android system, and null of draft resources represented by corresponding “−142” in the IOS system belong to the draft file exception.

Specifically, the video edit page represents a page for the user to edit and create the video edit draft. Exemplarily, the video edit page comprises a video preview area, an editing function navigation area and a track editing area, in which, the video preview area comprises a video preview window, the editing function navigation area comprises at least one editing function control, and the track editing area comprises a video track, a time shaft, a time axis scale and the like.

In an optional embodiment, preview frames related to the export failure event are displayed in the video preview window in the video edit page. The preview frames related to the export failure event represent video frames causing the export failure event in the video edit draft and can also represent black screen video frames. Specifically, the black screen video frames are suitable for a situation that the export error code is “−142”.

Exemplarily, at least one preview frame corresponding to the export failure event is acquired from the video export log, any one of the at least one preview frame is taken as the preview frame related to the export failure event, and the video edit page is displayed based on the preview frame related to the export failure event.

On the basis of the above embodiment, optionally, the failure prompt message corresponding to the edit page returning strategy in the failure prompt page is “Draft file exception, please check whether the material at xx seconds is normal” or “Draft file exception, please check the material at xx seconds”. In which, “material at xx seconds” refers to the preview frame related to the export failure event, and “xx seconds” indicates the positioning moment of the video frame related to the export failure event in the video edit draft.

FIG. 2 is a schematic diagram of a failure prompt page generated according to an edit page returning strategy provided by an embodiment of the present invention. Specifically, the “Export failure: Draft file exception, please check whether the material at xx seconds is normal” in FIG. 2 indicates the failure prompt message: a diagonal pattern below the failure prompt message indicates a cover image in the video edit draft; and a “Check” control indicates a prompt action control, while a “Done” control indicates a status display control.

In another optional embodiment, the acquiring an export preprocessing strategy corresponding to the export failure type comprises: when the export failure type is the decoder exception, taking an entry page returning strategy as the export preprocessing strategy, in which, the entry page returning strategy represents displaying an entry page of the video editing application.

For example, failures such as encoding and decoding module exception represented by corresponding “−12912” in the IOS system, and failed to create an image decoder represented by corresponding “−312”, not supported to image decoding represented by corresponding “−330”, and failed to create a decoder represented by corresponding “4390)” in the Android system belong to the decoder exception.

On the basis of the above embodiment, optionally, the failure prompt message corresponding to the entry page returning strategy in the failure prompt page can be “Please exit the draft and then try to export again”.

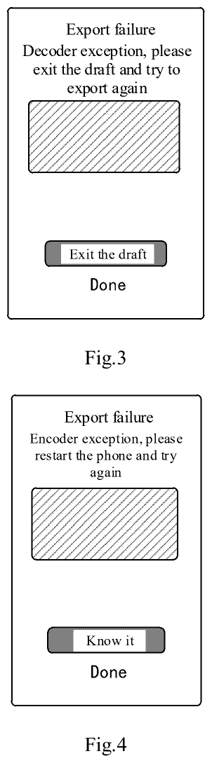

FIG. 3 is a schematic diagram of a failure prompt page generated according to an entry page returning strategy provided by an embodiment of the present invention. Specifically, the “Export failure: Decoder exception, please exit the draft and try to export again” indicates the failure prompt message: the diagonal pattern below the failure prompt message indicates the cover image of the video edit draft; and an “Exit the draft” control indicates a prompt operation control, while a “Done” control indicates the status display control.

In another optional embodiment, the acquiring an export preprocessing strategy corresponding to the export failure type comprises: when the export failure type is the encoder exception, taking a device restarting strategy corresponding to the device operating system as the export preprocessing strategy, in which, the device restarting strategy corresponding to the IOS system represents displaying the video edit page, or, the device restarting strategy corresponding to the Android system represents restarting the device running the video editing application.

Exemplarily, failures such as encoding and decoding module exception represented by corresponding “−12912”, failed to create a virtualization instance represented by corresponding “−12907”, and encoding module failure represented by corresponding “−12915” in the IOS system belong to the decoder exception.

On the basis of the above embodiment, optionally, the failure prompt message corresponding to the device restarting strategy in the failure prompt page can be “Please restart the phone and try again”.

FIG. 4 is a schematic diagram of a failure prompt page generated according to a device restarting strategy provided by an embodiment of the present invention. Specifically, the “Export failure: Encoder exception, please restart the phone and try again” indicates the failure prompt message: the diagonal pattern below the failure prompt message indicates the cover image in the video edit draft; and an “Know it” control indicates a prompt operation control generated according to the corresponding device restarting strategy of the IOS system, while the “Done” control indicates the status display control. On the basis of the example in FIG. 4, the prompt operation control generated according to the corresponding device restarting policy in the Android system can be a “Restart the phone” control.

In the technical solution of this embodiment, the method comprises: in the exporting process of the video edit draft, in response to the detected export failure event, determining the device operating system of the device running the video editing application and the export error code corresponding to the export failure event, so as to identify the export failure type of the export failure event; and displaying the failure prompt page according to the export preprocessing strategy corresponding to the export failure type, in which, the failure prompt page comprises the prompt operation control configured to execute the processing operation corresponding to the export preprocessing strategy; and therefore, the user is guided to solve and treat the export failure event by the prompt operation control, the problem that the solutions for the video export failure are single is solved, the stability of the video export function is improved, and the negative feedback of the video export is reduced.

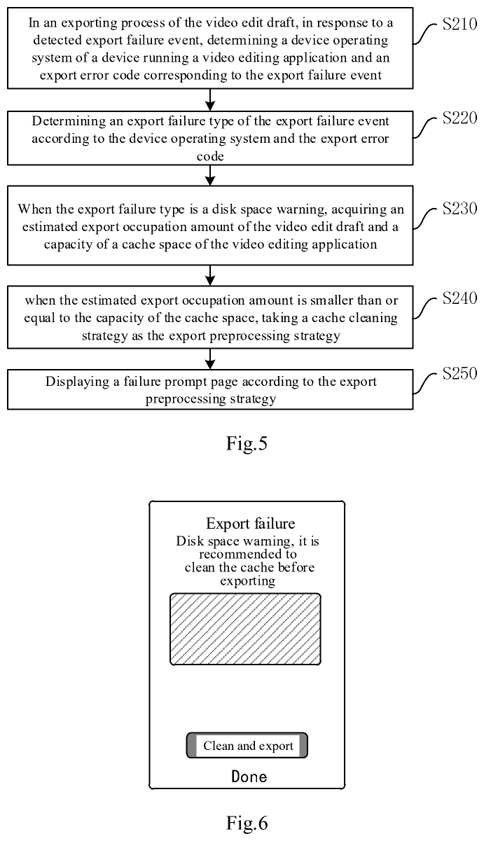

FIG. 5 is a flowchart of another method for processing video export provided by an embodiment of the present invention, and in this embodiment, the “acquiring an export preprocessing strategy corresponding to the export failure type” in the above embodiment is further detailed. In this embodiment, the acquiring an export preprocessing strategy corresponding to the export failure type comprises: when the export failure type is the disk space warning, acquiring an estimated export occupation amount of the video edit draft and the capacity of the cache space of the video editing application; and when the estimated export occupation amount is smaller than or equal to the capacity of the cache space, taking a cache cleaning strategy as the export preprocessing strategy. As shown in FIG. 5, the method comprises:

S210: in the exporting process of the video edit draft, in response to a detected export failure event, determining a device operating system of a device running a video editing application and an export error code corresponding to the export failure event.

S220: determining an export failure type of the export failure event according to the device operating system and the export error code.

The S210-S220 in this embodiment are correspondingly the same as or similar to the S110-S120 shown in FIG. 1 in the above embodiment, and will not be listed in this embodiment.

S230: when the export failure type is the disk space warning, acquiring an estimated export occupation amount of a video edit draft and a capacity of a cache space of the video editing application.

Specifically, the estimated export occupation amount represents the file space occupied by exporting the video edit draft as the video file, and the capacity of the cache space represents the storage capacity of the cache space of the video editing application.

In an optional embodiment, the product between the bit rate of the video edit draft and the video duration is divided by 8 to obtain the estimated export occupation amount of the video edit draft.

S240: when the estimated export occupation amount is smaller than or equal to the capacity of the cache space, taking a cache cleaning strategy as the export preprocessing strategy.

In an optional embodiment, the cache cleaning strategy at least represents cleaning the cache space of the video editing application, so as to ensure that the space occupation amount of the cache space is zero, or to make the residual capacity of the cache space greater than or equal to the estimated export occupation amount.

In an optional embodiment, the acquiring an export preprocessing strategy corresponding to the export failure type further comprises: when the estimated export occupation amount is greater than the capacity of the cache space, taking the edit page returning strategy as the export preprocessing strategy.

Specifically, the edit page returning strategy is convenient for the user to delete, replace or change video parameters of the video material of the video edit draft in the video edit page so as to reduce the estimated export occupation amount.

In another optional embodiment, the acquiring an export preprocessing strategy corresponding to the export failure type further comprises: when the estimated export occupation amount is greater than the capacity of the cache space, acquiring the capacity of the recycle bin space of the video editing application; and in response that the estimated export occupation amount is smaller than or equal to the capacity of the recycle bin space, taking a recycle bin cleaning strategy as the export preprocessing strategy.

Specifically, the capacity of the recycle bin space represents the storage capacity of the recycle bin of the video editing application. In an optional embodiment, the recycle bin cleaning strategy at least represents cleaning the recycle bin of the video editing application, so as to ensure that the space occupation amount of the recycle bin is zero, or to make the residual capacity of the recycle bin greater than or equal to the estimated export occupation amount.

On the basis of the above embodiment, optionally, the acquiring an export preprocessing strategy corresponding to the export failure type further comprises: when the estimated export occupation amount is greater than the capacity of the recycle bin space, taking the edit page returning strategy as the export preprocessing strategy.

In another optional embodiment, the acquiring an export preprocessing strategy corresponding to the export failure type further comprises: when the estimated export occupation amount is greater than the capacity of the recycle bin, acquiring the capacity of the system storage space of the device running the video editing application; and in response that the estimated export occupation amount is smaller than or equal to the capacity of the system storage space, taking the system space cleaning strategy corresponding to the device operating system as the export preprocessing strategy.

On the basis of the above embodiment, optionally, the acquiring an export preprocessing strategy corresponding to the export failure type further comprises: when the estimated export occupation amount is greater than the capacity of the system storage space, taking the page edit returning strategy as the export preprocessing strategy.

S250): displaying the failure prompt page according to the export preprocessing strategy.

In an optional embodiment, when the export preprocessing strategy is the cache cleaning strategy, the failure prompt message on the failure prompt page will be “Disk space warning, it is recommended to clean the cache before exporting”: when the export preprocessing strategy is the recycle bin cleaning strategy, the failure prompt message on the failure prompt page will be “Disk space warning, it is recommended to clean the recycle bin before exporting”; and when the export preprocessing strategy is the system space cleaning strategy, the failure prompt message on the failure prompt page will be “Disk space warning, it is recommended to clean the system space before exporting”.

In an optional implementation, when the export failure type is the disk space warning, and the export preprocessing strategy is the edit page returning strategy, the failure prompt message on the failure prompt page will be “Disk space warning, please cut the draft materials”.

On the basis of the above embodiment, optionally, after displaying a failure prompt page according to the export preprocessing strategy, the method further comprises: when the export preprocessing strategy is the cache cleaning strategy, in response to the trigger operation inputted for the prompt operation control, performing a cleaning operation on the cache space of the video editing application; and after the cleaning operation, performing an export operation on the video edit draft, and displaying the video export page.

On the basis of the above embodiment, optionally, after displaying a failure prompt page according to the export preprocessing strategy, the method further comprises: when the export preprocessing strategy is the recycle bin cleaning strategy, in response to the trigger operation inputted for the prompt operation control, performing a cleaning operation on the recycle bin of the video editing application; and after the cleaning operation, performing an export operation on the video edit draft, and displaying the video export page.

In this embodiment, the cache cleaning strategy and the recycle bin cleaning strategy further represent automatically performing the export operation of the video edit draft and displaying the video export page.

In an optional embodiment, in the process of performing the cleaning operation on the cache space or performing the cleaning operation on the recycle bin, cleaning prompt message will be displayed on the failure prompt page. Exemplarily, the cleaning prompt message can be “Cleaning”. This setting has the advantages that the user can conveniently know the execution condition of the cache cleaning strategy or the recycle bin cleaning strategy in real time.

FIG. 6 is a schematic diagram of a failure prompt page generated according to a cache cleaning strategy provided by an embodiment of the present invention. Specifically, in FIG. 6, “Export failure: Disk space warning, it is recommended to clear the cache before exporting” indicates the failure prompt message: the diagonal pattern below the failure prompt message represents the cover image in the video edit draft; and a “Clear and Export” control indicates the prompt operation control, while the “Done” control indicates the status display control.

FIG. 7 is a schematic diagram of a failure prompt page generated according to a recycle bin cleaning strategy provided by an embodiment of the present invention. Specifically, in FIG. 7, “Export failure: Disk space warning, it is recommended to clear the recycle bin before exporting” indicates the failure prompt message: the diagonal pattern below the failure prompt message indicates the cover image in the video edit draft; and the “Clean and Export” control indicates the prompt operation control, while the “Done” control indicates the status display control.

On the basis of the embodiment, optionally, after displaying a failure prompt page according to the export preprocessing strategy, the method further comprises: when the export preprocessing strategy is the system space cleaning strategy corresponding to the IOS system, in response to a trigger operation inputted for the prompt operation control, replacing the prompt operation control with an export retry control, and displaying the cleaning prompt message on the failure prompt page, in which, the cleaning prompt message is used for prompting the user to open a system space management page for space cleaning.

On the basis of the embodiment, optionally, after displaying a failure prompt page according to the export preprocessing strategy, the method further comprises: when the export preprocessing strategy is the system space cleaning strategy corresponding the Android system, in response to a trigger operation inputted for the prompt operation control, skipping to display the system space management page, and in response to a detected application switching back operation, performing an export operation on the video edit draft, and displaying the video export page.

Specifically, the export retry control is configured to execute the export operation on the video edit draft and display the video export page, and the application switching back operation represents that the user switches back to the video editing application from the application with the system management page.

FIG. 8 is a schematic diagram of a failure prompt page generated according to a system space cleaning strategy provided by an embodiment of the present invention, and in FIG. 8, the system space cleaning strategy corresponding to the IOS system is taken as an example. Specifically, the left page in FIG. 8 represents the failure prompt page before performing the system space cleaning strategy, while the right page in FIG. 8 represents the failure prompt page during the execution of the system space cleaning strategy: In FIG. 8, “Export failure: Disk space warning, it is recommended to clean up the system space before exporting” indicates the failure prompt message: the diagonal pattern below the failure prompt message indicates the cover image in the video edit draft, while the “Done” control indicates the status display control.

In the left page, a “Clean system space’ control indicates the prompt operation control”. In the right page, “Open System settings-General-Storage space, manually clean the system storage space” indicates cleaning prompt message; and an “Export retry” control indicates an export retry control.

According to the technical solution of this embodiment, when the export failure type is the disk space warning, the estimated export occupation amount of the video edit draft is sequentially compared with the capacity of the cache space, the capacity of the recycle bin and the capacity of the system storage space, and the cache cleaning strategy, the recycle bin cleaning strategy and the system space cleaning strategy are correspondingly set, thus solving the problem that solutions for disk space warning are simple, further improving the stability of the video export function, and further reducing negative feedback of video export.

On the basis of the above embodiment, optionally, the method further comprises: in the exporting process of the video edit draft, acquiring a video export weight corresponding to the video edit draft; according to the video export weight and a post-processing weight corresponding to an export post-processing process, determining a progress correction ratio; and taking the product of the current export progress of the video edit draft and the progress correction ratio as a corrected export progress, and displaying the corrected export progress in the video export page.

Specifically, the video export weight represents a weight value corresponding to the exporting process of exporting the video edit draft as the video file.

In an optional embodiment, the acquiring a video export weight corresponding to the video edit draft comprises: taking the product of the estimated export occupation amount of the video edit draft and a preset ratio as the video export weight of the video edit draft.

In another optional embodiment, the acquiring a video export weight corresponding to the video edit draft comprises: when the current export progress is a preset export progress, acquiring reference export time corresponding to the current export progress, and taking the ratio of the reference export time to the preset export progress as the estimated total export time corresponding to the video edit draft; and taking the ratio of the estimated total export time to the estimated export occupation amount of the video edit draft as the video export weight of the video edit draft.

Exemplarily, the preset export progress may be 20%, which is not limited herein and can be specifically customized according to actual demands.

The actual export progress of the video edit draft is not only related to the estimated export occupation amount, but also is influenced by complex factors such as the application version of the video editing application, the system resource settings, the file format of the video file, the resolution, the encoder algorithm and the decoder algorithm. In this embodiment, the actual export time corresponding to the preset export progress is used as the reference export time and is used for determining the video export weight of the video edit draft, so that the accuracy of the video export weight can be improved, and the accuracy of the corrected export progress is further ensured.

Specifically, the export post-processing flow represents the post-processing operation performed by the user on the video file after the video edit draft is exported as the video file. Exemplarily, the export post-processing flow comprises, but is not limited to, saving to the album, publishing to the video platform, importing to the video editing application, etc., which is not limited herein, and correspondingly, in this embodiment, there is no limitation to the post-processing weight, and it can be customized according to the actual demand.

Exemplarily, the progress correction ratio meets the following formula:

$$ratio = \frac{1}{1 + \frac{b}{a}}$$

in which, a indicates the video export weight, and b indicates the post-processing weight.

In this embodiment, in response that the current export progress is less than or equal to the preset export progress, the current export progress is displayed on the video export page; and in response that the current export progress is greater than the preset export progress, the corrected export progress is displayed on the video export page.

The export post-processing flow is a flow step closely linked to the export flow, and the export post-processing flow also consumes time, but the export progress displayed on the current video export page only represents the encoding and decoding progress of the video edit draft, and cannot provide progress feedback about the export post-processing flow. In this embodiment, the export progress is corrected according to the video export weight and the post-processing weight, so that the export progress displayed on the video export page can represent the encoding and decoding progress of the video edit draft as well as the post-processing progress of the export post-processing flow, thereby improving the integrity and accuracy of the export progress.

The following is an embodiment of a processing apparatus for video export provided by the embodiment of the present invention, the apparatus and the method for processing video export in the above embodiment belong to the same inventive concept, and the details not described in the embodiment of the processing apparatus for video export can be referred to the details about the method for processing video export in the above embodiment.

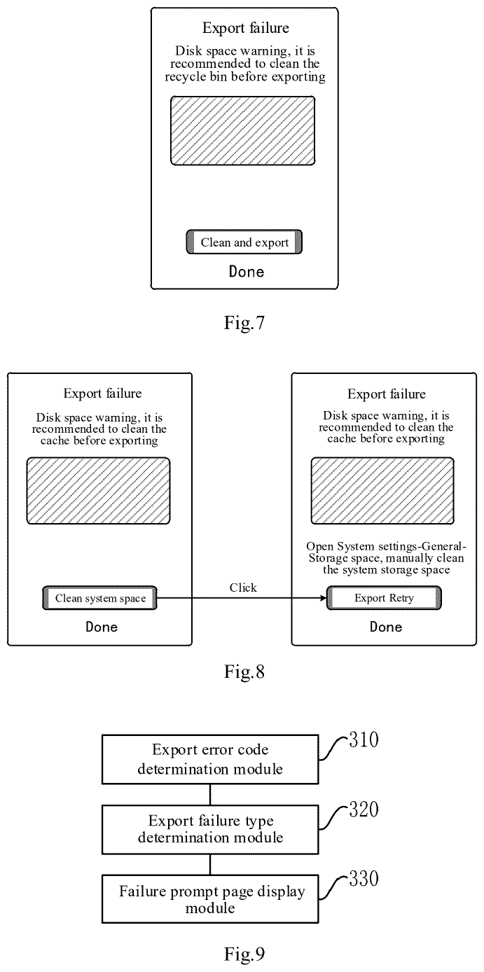

FIG. 9 is a schematic structural diagram of a processing apparatus for video export provided by an embodiment of the present invention. As shown in FIG. 9, the apparatus comprises: an export error code determination module 310, an export failure type determination module 320 and a failure prompt page display module 330.

The export error code determination module 310 is configured to: in an exporting process of a video edit draft, in response to a detected export failure event, determine a device operating system of a device running a video editing application and an export error code corresponding to the export failure event:
the export failure type determination module 320 is configured to determine an export failure type of the export failure event according to the device operating system and the export error code;
the failure prompt page display module 330 is configured to acquire an export preprocessing strategy corresponding to the export failure type, and display a failure prompt page according to the export preprocessing strategy;
wherein the failure prompt page comprises a prompt operation control which is configured to perform a processing operation corresponding to the export preprocessing strategy.

In the technical solution of this embodiment, the method comprises: in the exporting process of the video edit draft, in response to the detected export failure event, determining the device operating system of the device running the video editing application and the export error code corresponding to the export failure event, so as to identify the export failure type of the export failure event; and displaying the failure prompt page according to the export preprocessing strategy corresponding to the export failure type, in which, the failure prompt page comprises the prompt operation control configured to execute the processing operation corresponding to the export preprocessing strategy; and therefore, the user is guided to solve and treat the export failure event by the prompt operation control, the problem that the solutions for the video export failure are single is solved, the stability of the video export function is improved, and the negative feedback of the video export is reduced.

In an optional embodiment, the failure prompt page display module 330 comprises:
a first export preprocessing strategy determination unit, configured to: when the export failure type is a disk space warning, acquire an estimated export occupation amount of the video edit draft and a capacity of a cache space of the video editing application; and
when the estimated export occupation amount is smaller than or equal to the capacity of the cache space, take a cache cleaning strategy as the export preprocessing strategy.

In an optional embodiment, the apparatus further comprises:
a cache cleaning strategy execution module, configured to: after the displaying a failure prompt page according to the export preprocessing strategy, in response to a trigger operation inputted for the prompt operation control, perform a cleaning operation on the cache space of the video editing application; and after the cleaning operation is completed, perform an export operation on the video edit draft, and display a video export page.

In an optional embodiment, the failure prompt page display module 330) also comprises:
a second export preprocessing strategy determination unit, configured to: when the estimated export occupation amount is greater than the capacity of the cache space, acquire a capacity of a recycle bin space of the video editing application; and
in response that the estimated export occupation amount is smaller than or equal to the capacity of the recycle bin space, take a recycle bin cleaning strategy as the export preprocessing strategy.

In an optional embodiment, the apparatus further comprises:
a recycle bin cleaning strategy executing module, configured to: in response to a trigger operation inputted for the prompt operation control, perform a cleaning operation on the recycle bin of the video editing application; and after the cleaning operation, perform an export operation on the video edit draft, and display a video export page.

In an optional embodiment, the failure prompt page display module 330 further comprises:
a third export preprocessing strategy determination unit, configured to: when the estimated export occupation amount is greater than the capacity of the recycle bin space, acquire a capacity of a system storage space of the device running the video editing application; and
in response that the estimated export occupation amount is smaller than or equal to the capacity of the system storage space, take a system space cleaning strategy corresponding to the device operating system as the export preprocessing strategy.

In an optional embodiment, the apparatus further comprises:
a first system space cleaning strategy preforming module, configured to: after the displaying a failure prompt page according to the export preprocessing strategy, when the export preprocessing strategy is the system space cleaning strategy corresponding to an IOS system, in response to a trigger operation inputted for the prompt operation control, replace the prompt operation control with an export retry control, and display a cleaning prompt message on the failure prompt page, wherein the cleaning prompt message is used for prompting a user to open a system space management page for space cleaning.

In an optional embodiment, the apparatus further comprises:
a second system space clean strategy execution module, configured to: after the displaying a failure prompt page according to the export preprocessing strategy, when the export preprocessing strategy is the system space cleaning strategy corresponding an Android system, in response to a trigger operation inputted for the prompt operation control, skip to display a system space management page, and in response to detecting an application switching back operation, perform an export operation on the video edit draft, and display a video export page.

In an optional embodiment, the failure prompting page display module 330 comprises:
a fourth export preprocessing strategy determination unit, configured to: when the export failure type is a draft file exception, take an edit page returning strategy as the export preprocessing strategy, in which, the edit page returning strategy represents displaying a video edit page;
when the export failure type is a decoder exception, take an entry page returning strategy as the export preprocessing strategy, in which, the entry page returning strategy represents displaying an entry page of the video editing application; and
when the export failure type is an encoder exception, take a device restarting strategy corresponding to the device operating system as the export preprocessing strategy,
wherein the device restarting strategy corresponding to the IOS system represents displaying the video edit page, or, the device restarting strategy corresponding to the Android system represents restarting the device running the video editing application.

In an optional embodiment, the export failure type determination module 320 is specifically configured to:
acquire an export error code list corresponding to the device operating system, wherein, the export error code list comprises an error code sequence corresponding to at least one preset failure type, and the error code sequence comprises at least one preset error code; and
search the export failure type of the export failure event from the export error code list, according to the export error code.

In an optional embodiment, the failure prompt page further comprises failure prompt message which comprises at least one selected from a group of the export failure type and strategy description content corresponding to the export preprocessing strategy.

In an optional embodiment, the apparatus further comprises:
a correction export progress display module, configured to: in the exporting process of the video edit draft, acquire a video export weight corresponding to the video edit draft;
according to the video export weight and a post-processing weight corresponding to an export post-processing process, determine a progress correction ratio; and
take a product of a current export progress of the video edit draft and the progress correction ratio as a corrected export progress, and display the corrected export progress in a video export page.

In an optional embodiment, the correction export progress display module is specifically configured to:
when the current export progress is a preset export progress, acquire reference export time corresponding to the current export progress, and take a ratio of the reference export time to the preset export progress as an estimated total export time corresponding to the video edit draft; and
take a ratio of the estimated total export time to the estimated export occupation amount of the video edit draft as the video export weight of the video edit draft.

The video export processing apparatus provided by the embodiment of the present invention can implement the method for processing video export provided by any embodiment of the present invention, and has corresponding functional modules for performing the method and corresponding beneficial effects.

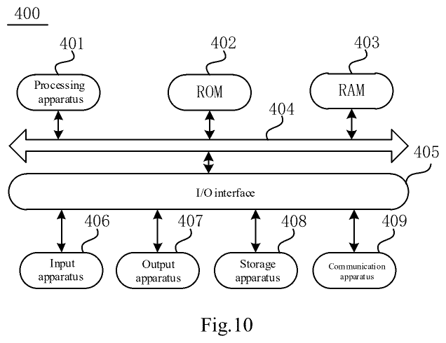

With reference to FIG. 10, which shows a schematic structural diagram of an electronic device (such as a terminal device or a server) 400 suitable for implementing this embodiment of the present invention. The terminal equipment in this embodiment of the present invention may comprise, but is not limited to, mobile terminals such as mobile telephones, notebook computers, digital broadcast receivers, PDAs (personal digital assistants), PADs (tablet computers), PMPs (portable multimedia players), and vehicle-mounted terminals (such as vehicle-mounted navigation terminals), as well as fixed terminals such as digital televisions, and desktop computers. The electronic device shown in FIG. 10 is only an example and should not impose any limitation on the function and scope of use of the embodiments of the present invention.

As shown in FIG. 10, the electronic device 400) may comprise a processing apparatus (such as a central processing unit, and a graphics processing unit) 401, which can execute various appropriate actions and processes according to programs stored in a read-only memory (ROM) 402 or programs loaded from the storage apparatus 406 to a random access memory (RAM) 403. In the RAM 403, various programs and data necessary for the operation of the electronic apparatus 400) are also stored. The processing apparatus 401, the ROM 402 and the RAM 403 are connected to each other via buses 404. The input/output (I/O) interface 405 is also connected to the bus 404.

In general, the following apparatuses can be connected to the I/O interface 405: comprising an input apparatus 406 such as a touch screen, a touch pad, a keyboard, a mouse, a camera, a microphone, an accelerometer, and a gyroscope: comprising an output apparatus 407 such as a liquid crystal display (LCD), a speaker, and a vibrator: a storage apparatus 408 such as a tape, and a hard disk; and a communication apparatus 409. The communication apparatus 409 may allow the electronic device 400) to communicate wirelessly or wired with other devices for the exchange of data. Although FIG. 10 shows the electronic device 400 with various apparatuses, it is to be understood that it is not required to implement or have all of the apparatuses shown. It is possible to implement alternatively or to have more or fewer apparatuses.

In particular, according to the embodiments of the present invention, the process described with reference to the flowchart may be implemented as a computer software program. For example, an embodiment of the present invention comprises a computer program product which comprises a computer program carried on a non-transient computer-readable medium, and the computer-readable medium contains program codes for performing the method shown in the flowchart. In such embodiment, the computer program may be downloaded and installed from a network by the communication apparatus 409, or installed from the storage apparatus 408, or installed from the ROM 402. When the computer program is executed by the processing apparatus 401, it executes the functions limited in the method of the embodiment of the present invention.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: in an exporting process of a video edit draft, in response to a detected export failure event, determine a device operating system of a device running a video editing application and an export error code corresponding to the export failure event: determine an export failure type of the export failure event according to the device operating system and the export error code; and acquire an export preprocessing strategy corresponding to the export failure type, and display a failure prompt page according to the export preprocessing strategy, wherein the failure prompt page comprises a prompt operation control which is configured to execute a processing operation corresponding to the export preprocessing strategy.

The computer program codes for performing the operations of the present disclosure may be written in one or more programming languages or a combination thereof. The above-mentioned programming languages include but are not limited to object-oriented programming languages such as Java. Smalltalk. C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances, for example, the first acquisition unit may also be described as “a unit that acquires at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

One or more embodiments of the present disclosure provide a method for processing video export, which comprises:
in an exporting process of a video edit draft, in response to a detected export failure event, determining a device operating system of a device running a video editing application and an export error code corresponding to the export failure event;
determining an export failure type of the export failure event according to the device operating system and the export error code; and
acquiring an export preprocessing strategy corresponding to the export failure type, and displaying a failure prompt page according to the export preprocessing strategy,
wherein the failure prompt page comprises a prompt operation control which is configured to execute a processing operation corresponding to the export preprocessing strategy.

According to one or more embodiments of the present disclosure, the acquiring an export preprocessing strategy corresponding to the export failure type comprises:
when the export failure type is a disk space warning, acquiring an estimated export occupation amount of the video edit draft and a capacity of a cache space of the video editing application; and
when the estimated export occupation amount is smaller than or equal to the capacity of the cache space, taking a cache cleaning strategy as the export preprocessing strategy.

According to one or more embodiments of the present disclosure, after displaying a failure prompt page according to the export preprocessing strategy, the method further comprises:
in response to a trigger operation inputted for the prompt operation control, performing a cleaning operation on the cache space of the video editing application; and after the cleaning operation is completed, performing an export operation on the video edit draft, and displaying a video export page.

According to one or more embodiments of the present disclosure, the acquiring an export preprocessing strategy corresponding to the export failure type further comprises:
when the estimated export occupation amount is greater than the capacity of the cache space, acquiring a capacity of a recycle bin space of the video editing application; and
in response that the estimated export occupation amount is smaller than or equal to the capacity of the recycle bin space, taking a recycle bin cleaning strategy as the export preprocessing strategy.

According to one or more embodiments of the present disclosure, after displaying a failure prompt page according to the export preprocessing strategy, the method further comprises:
in response to a trigger operation inputted for the prompt operation control, performing a cleaning operation on the recycle bin of the video editing application; and after the cleaning operation, performing an export operation on the video edit draft, and displaying a video export page.

According to one or more embodiments of the present disclosure, the acquiring an export preprocessing strategy corresponding to the export failure type further comprises:
when the estimated export occupation amount is greater than the capacity of the recycle bin space, acquiring a capacity of a system storage space of the device running the video editing application; and
in response that the estimated export occupation amount is smaller than or equal to the capacity of the system storage space, taking a system space cleaning strategy corresponding to the device operating system as the export preprocessing strategy.

According to one or more embodiments of the present disclosure, after the displaying a failure prompt page according to the export preprocessing strategy, the method further comprises:
when the export preprocessing strategy is the system space cleaning strategy corresponding to an IOS system, in response to a trigger operation inputted for the prompt operation control, replacing the prompt operation control with an export retry control, and displaying a cleaning prompt message on the failure prompt page, wherein the cleaning prompt message is used for prompting a user to open a system space management page for space cleaning.

According to one or more embodiments of the present disclosure, after displaying a failure prompt page according to the export preprocessing strategy, the method further comprises:
when the export preprocessing strategy is the system space cleaning strategy corresponding an Android system, in response to a trigger operation inputted for the prompt operation control, skipping to display a system space management page, and in response to detecting an application switching back operation, performing an export operation on the video edit draft, and displaying a video export page.

According to one or more embodiments of the present disclosure, the acquiring an export preprocessing strategy corresponding to the export failure type comprises:
when the export failure type is a draft file exception, taking an edit page returning strategy as the export preprocessing strategy, in which, the edit page returning strategy represents displaying a video edit page;
when the export failure type is a decoder exception, taking an entry page returning strategy as the export preprocessing strategy, in which, the entry page returning strategy represents displaying an entry page of the video editing application; and
when the export failure type is an encoder exception, taking a device restarting strategy corresponding to the device operating system as the export preprocessing strategy,
wherein the device restarting strategy corresponding to the IOS system represents displaying the video edit page, or, the device restarting strategy corresponding to the Android system represents restarting the device running the video editing application.

According to one or more embodiments of the present disclosure, the determining an export failure type of the export failure event according to the device operating system and the export error code comprises:
acquiring an export error code list corresponding to the device operating system, wherein the export error code list comprises an error code sequence corresponding to at least one preset failure type, and the error code sequence comprises at least one preset error code; and
searching the export failure type of the export failure event from the export error code list, according to the export error code.

According to one or more embodiments of the present disclosure, the failure prompt page further comprises failure prompt message which comprises at least one selected from a group of the export failure type and strategy description content corresponding to the export preprocessing strategy.

According to one or more embodiments of the present disclosure, the method further comprising:
in the exporting process of the video edit draft, acquiring a video export weight corresponding to the video edit draft;
according to the video export weight and a post-processing weight corresponding to an export post-processing process, determining a progress correction ratio; and
taking a product of a current export progress of the video edit draft and the progress correction ratio as a corrected export progress, and displaying the corrected export progress in a video export page.

According to one or more embodiments of the present disclosure, the acquiring a video export weight corresponding to the video edit draft comprises:
when the current export progress is a preset export progress, acquiring reference export time corresponding to the current export progress, and taking a ratio of the reference export time to the preset export progress as an estimated total export time corresponding to the video edit draft; and
taking a ratio of the estimated total export time to the estimated export occupation amount of the video edit draft as the video export weight of the video edit draft.

According to one or more embodiments of the present disclosure, an apparatus for processing video export is provided, which comprises:
an export error code determination module, configured to: in an exporting process of a video edit draft, in response to a detected export failure event, determine a device operating system of a device running a video editing application and an export error code corresponding to the export failure event;
an export failure type determination module, configured to determine an export failure type of the export failure event according to the device operating system and the export error code; and
a failure prompt page display module, configured to acquire an export preprocessing strategy corresponding to the export failure type, and displaying a failure prompt page according to the export preprocessing strategy; and
wherein the failure prompt page comprises a prompt operation control which is configured to execute a processing operation corresponding to the export preprocessing strategy.

According to one or more embodiments of the present disclosure, an electronic device is provided, which comprises:
at least one processor; and
a memory communicatively connected with the at least one processor, wherein
the memory stores a computer program executable by the at least one processor, and the computer program, when executed by the at least one processor, causes the at least one processor to perform the method for processing video export according to the above-mentioned embodiments.

According to one or more embodiments of the present disclosure, a non-transitory computer-readable storage medium is provided, wherein the computer-readable storage medium is stored with computer instructions, and the computer instructions, when executed by at least a processor, cause the processor to implement the method for processing video export according to the above-mentioned embodiments.

According to one or more embodiments of the present disclosure, a computer program product is provided, the computer program comprising a computer program which is executed by a processor to execute the method for processing video export according to the above-mentioned embodiments.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for processing video export, comprising:
in an exporting process of a video edit draft, in response to a detected export failure event, determining a device operating system of a device running a video editing application and an export error code corresponding to the export failure event;
determining an export failure type of the export failure event according to the device operating system and the export error code; and
acquiring an export preprocessing strategy corresponding to the export failure type, and displaying a failure prompt page according to the export preprocessing strategy,
wherein the failure prompt page comprises a prompt operation control which is configured to execute a processing operation corresponding to the export preprocessing strategy.

2. The method according to claim 1, wherein the acquiring an export preprocessing strategy corresponding to the export failure type comprises:
when the export failure type is a disk space warning, acquiring an estimated export occupation amount of the video edit draft and a capacity of a cache space of the video editing application; and
when the estimated export occupation amount is smaller than or equal to the capacity of the cache space, taking a cache cleaning strategy as the export preprocessing strategy.

3. The method according to claim 2, wherein after the displaying a failure prompt page according to the export preprocessing strategy, the method further comprises:
in response to a trigger operation inputted for the prompt operation control, performing a cleaning operation on the cache space of the video editing application; and after the cleaning operation is completed, performing an export operation on the video edit draft, and displaying a video export page.

4. The method according to claim 2, wherein the acquiring an export preprocessing strategy corresponding to the export failure type further comprises:
when the estimated export occupation amount is greater than the capacity of the cache space, acquiring a capacity of a recycle bin space of the video editing application; and
in response that the estimated export occupation amount is smaller than or equal to the capacity of the recycle bin space, taking a recycle bin cleaning strategy as the export preprocessing strategy.

5. The method according to claim 4, wherein after the displaying a failure prompt page according to the export preprocessing strategy, the method further comprises:
in response to a trigger operation inputted for the prompt operation control, performing a cleaning operation on the recycle bin of the video editing application; and after the cleaning operation, performing an export operation on the video edit draft, and displaying a video export page.

6. The method according to claim 4, wherein the acquiring an export preprocessing strategy corresponding to the export failure type further comprises:
when the estimated export occupation amount is greater than the capacity of the recycle bin space, acquiring a capacity of a system storage space of the device running the video editing application; and
in response that the estimated export occupation amount is smaller than or equal to the capacity of the system storage space, taking a system space cleaning strategy corresponding to the device operating system as the export preprocessing strategy.

7. The method according to claim 6, wherein after the displaying a failure prompt page according to the export preprocessing strategy, the method further comprises:
when the export preprocessing strategy is the system space cleaning strategy corresponding to an IOS system, in response to a trigger operation inputted for the prompt operation control, replacing the prompt operation control with an export retry control, and displaying a cleaning prompt message on the failure prompt page, wherein the cleaning prompt message is used for prompting a user to open a system space management page for space cleaning.

8. The method according to claim 6, wherein after the displaying a failure prompt page according to the export preprocessing strategy, the method further comprises:
when the export preprocessing strategy is the system space cleaning strategy corresponding an Android system, in response to a trigger operation inputted for the prompt operation control, skipping to display a system space management page, and in response to detecting an application switching back operation, performing an export operation on the video edit draft, and displaying a video export page.

9. The method according to claim 1, wherein the acquiring an export preprocessing strategy corresponding to the export failure type comprises:
when the export failure type is a draft file exception, taking an edit page returning strategy as the export preprocessing strategy, in which, the edit page returning strategy represents displaying a video edit page;
when the export failure type is a decoder exception, taking an entry page returning strategy as the export preprocessing strategy, in which, the entry page returning strategy represents displaying an entry page of the video editing application; and
when the export failure type is an encoder exception, taking a device restarting strategy corresponding to the device operating system as the export preprocessing strategy,
wherein the device restarting strategy corresponding to the IOS system represents displaying the video edit page, or, the device restarting strategy corresponding to the Android system represents restarting the device running the video editing application.

10. The method according to claim 1, wherein the determining an export failure type of the export failure event according to the device operating system and the export error code comprises:
acquiring an export error code list corresponding to the device operating system, wherein the export error code list comprises an error code sequence corresponding to at least one preset failure type, and the error code sequence comprises at least one preset error code; and
searching the export failure type of the export failure event from the export error code list, according to the export error code.

11. The method according to claim 1, wherein the failure prompt page further comprises failure prompt message which comprises at least one selected from a group of the export failure type and strategy description content corresponding to the export preprocessing strategy.

12. The method according to claim 1, further comprising:
in the exporting process of the video edit draft, acquiring a video export weight corresponding to the video edit draft;
according to the video export weight and a post-processing weight corresponding to an export post-processing process, determining a progress correction ratio; and
taking a product of a current export progress of the video edit draft and the progress correction ratio as a corrected export progress, and displaying the corrected export progress in a video export page.

13. The method according to claim 12, wherein the acquiring a video export weight corresponding to the video edit draft comprises:
when the current export progress is a preset export progress, acquiring reference export time corresponding to the current export progress, and taking a ratio of the reference export time to the preset export progress as an estimated total export time corresponding to the video edit draft; and
taking a ratio of the estimated total export time to the estimated export occupation amount of the video edit draft as the video export weight of the video edit draft.

14. An electronic device, comprising:
at least one processor; and
a memory communicatively connected with the at least one processor, wherein
the memory stores a computer program executable by the at least one processor, and the computer program, when executed by the at least one processor, causes the at least one processor to perform a method for processing video export, which comprises:
in an exporting process of a video edit draft, in response to a detected export failure event, determining a device operating system of a device running a video editing application and an export error code corresponding to the export failure event;
determining an export failure type of the export failure event according to the device operating system and the export error code; and
acquiring an export preprocessing strategy corresponding to the export failure type, and displaying a failure prompt page according to the export preprocessing strategy,
wherein the failure prompt page comprises a prompt operation control which is configured to execute a processing operation corresponding to the export preprocessing strategy.

15. The electronic device according to claim 14, wherein the acquiring an export preprocessing strategy corresponding to the export failure type comprises:
when the export failure type is a disk space warning, acquiring an estimated export occupation amount of the video edit draft and a capacity of a cache space of the video editing application; and
when the estimated export occupation amount is smaller than or equal to the capacity of the cache space, taking a cache cleaning strategy as the export preprocessing strategy.

16. The electronic device according to claim 15, wherein after the displaying a failure prompt page according to the export preprocessing strategy, the method further comprises:
in response to a trigger operation inputted for the prompt operation control, performing a cleaning operation on the cache space of the video editing application; and after the cleaning operation is completed, performing an export operation on the video edit draft, and displaying a video export page.

17. The electronic device according to claim 15, wherein the acquiring an export preprocessing strategy corresponding to the export failure type further comprises:
when the estimated export occupation amount is greater than the capacity of the cache space, acquiring a capacity of a recycle bin space of the video editing application; and
in response that the estimated export occupation amount is smaller than or equal to the capacity of the recycle bin space, taking a recycle bin cleaning strategy as the export preprocessing strategy.

18. The electronic device according to claim 17, wherein after the displaying a failure prompt page according to the export preprocessing strategy, the method further comprises:
in response to a trigger operation inputted for the prompt operation control, performing a cleaning operation on the recycle bin of the video editing application; and after the cleaning operation, performing an export operation on the video edit draft, and displaying a video export page.

19. The electronic device according to claim 17, wherein the acquiring an export preprocessing strategy corresponding to the export failure type further comprises:
when the estimated export occupation amount is greater than the capacity of the recycle bin space, acquiring a capacity of a system storage space of the device running the video editing application; and
in response that the estimated export occupation amount is smaller than or equal to the capacity of the system storage space, taking a system space cleaning strategy corresponding to the device operating system as the export preprocessing strategy.

20. A non-transitory computer-readable storage medium, wherein the computer-readable storage medium is stored with computer instructions, and the computer instructions, when executed by at least a processor, cause the processor to implement a method for processing video export, which comprises:
in an exporting process of a video edit draft, in response to a detected export failure event, determining a device operating system of a device running a video editing application and an export error code corresponding to the export failure event;
determining an export failure type of the export failure event according to the device operating system and the export error code; and
acquiring an export preprocessing strategy corresponding to the export failure type, and displaying a failure prompt page according to the export preprocessing strategy,
wherein the failure prompt page comprises a prompt operation control which is configured to execute a processing operation corresponding to the export preprocessing strategy.
